(19) United States
(12) Patent Application Publication
(10) Pub. No.: US 2010/0212557 A1
(43) Pub. Date: Aug. 26, 2010

(54) Fruit tree bonsai planting method

(76) Inventor: Chung-Peng Tien, Caotun Township (TW)

Correspondence Address: Chung-Peng Tien, P.O. Box No. 6-57, Junghe, Taipei, 235, TW

(21) Appl. No.: 12/656,745

(22) Filed: Feb. 16, 2010

(30) Foreign Application Priority Data
Feb. 26, 2009 (TW) 098106082

(51) Int. Cl. A01G 23/04; A01G 9/02; A01G 1/00

(52) U.S. Cl. 111/100; 47/6

(57) ABSTRACT

A fruit tree bonsai planting method includes primarily grafting a scion with a stock by an inarching method, with an inarched location being fastened tightly by a tape. A lower part of the scion is cut off when the inarched location is healed and then the stock is transplanted to a pot with fertile soil for fixing, thereby forming a fruit tree bonsai having an indoor decorative condition and edible fruits.

### BACKGROUND OF THE INVENTION

a) Field of the Invention

The present invention relates to a fruit tree bonsai and more particularly to a fruit tree bonsai method which uses an inarching method to quickly cultivate ripened fruits.

b) Description of the Prior Art

For an ordinary fruit bonsai, fruit shoots are planted in an orchard to grow for three years before being transplanted to flowerpots for cultivation for 3″ 4 years that fruits can be ripened. This kind of fruit bonsai planting method has a long growing time, a limited yield of production, a high cultivation cost and a relatively higher price of sale; therefore, it cannot be popular easily. There is another fruit bonsai planting method wherein fruit shoots are directly planted in flowerpots and implemented with a special fertilizer that the fruits can be ripened after 6″ 7 years. This fruit bonsai planting method has a long cultivation time, an imperfect bearing rate and small fruits which are ugly and bad to eat.

### SUMMARY OF THE INVENTION

To overcome the shortcomings of the prior art, the primary object of the present invention is to provide a fruit tree bonsai planting method which is provided with a condition of an indoor decorative bonsai and ripened fruits after being transplanted, thereby having features of green making, educating, air cleaning, improving an economical value of the fruits and promoting development of agriculture.

The technical means of the present invention is to provide a fruit tree bonsai planting method wherein a scion and a stock are primarily grafted by an inarching method, with an inarched location being fastened tightly by a tape, a lower part of the scion being cut off after the inarched location is healed and then the stock being transplanted to a pot with fertile soil for fixing, so as to form a fruit tree bonsai.

In the aforementioned fruit tree bonsai planting method of the present invention, more than one stub of the said stock can be selectively used to inarch with the scion, thereby increasing support to the scion.

In the aforementioned fruit tree bonsai planting method of the present invention, any one of following methods can be chosen to grow the said stock: (a) planting the stock in a plastic pot which is then fastened on a stock plant of the scion with a rope or is supported and fixed with a pore; (b) planting the stock in a flowerpot, a bottom of which is provided with plural holes, allowing a root of the stock to extend into the soil; (c) planting the stock directly in the soil.

In the aforementioned fruit tree bonsai planting method of the present invention, the said inarched location is pasted with a wound healing agent.

In the aforementioned fruit tree bonsai planting method of the present invention, the said fertile soil can be one of or a combination of more than one of garden soil, leaf mould and fine sandy soil.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow diagram of a preferred embodiment of a fruit tree bonsai planting method of the present invention.

FIG. 2 shows a schematic view of a first embodiment of a fruit tree bonsai of the present invention.

FIG. 3 shows a schematic view of a second embodiment of the fruit tree bonsai of the present invention.

FIG. 4 shows a schematic view of a third embodiment of the fruit tree bonsai of the present invention.

FIG. 5 shows a schematic view of a fourth embodiment of the fruit tree bonsai of the present invention.

### DETAILED DESCRIPTION OF THE PREFERRED EMBODIMENTS

The method disclosed by the present invention can be applied to planting, cultivation and quick mass production of any fruit tree bonsai, enabling the fruit tree bonsai to achieve a value of decoration and fruits to be edible. The present invention is educational, can make green and beautify environment, and is able to improve indoor air quality and to improve an economical value of the fruit tree.

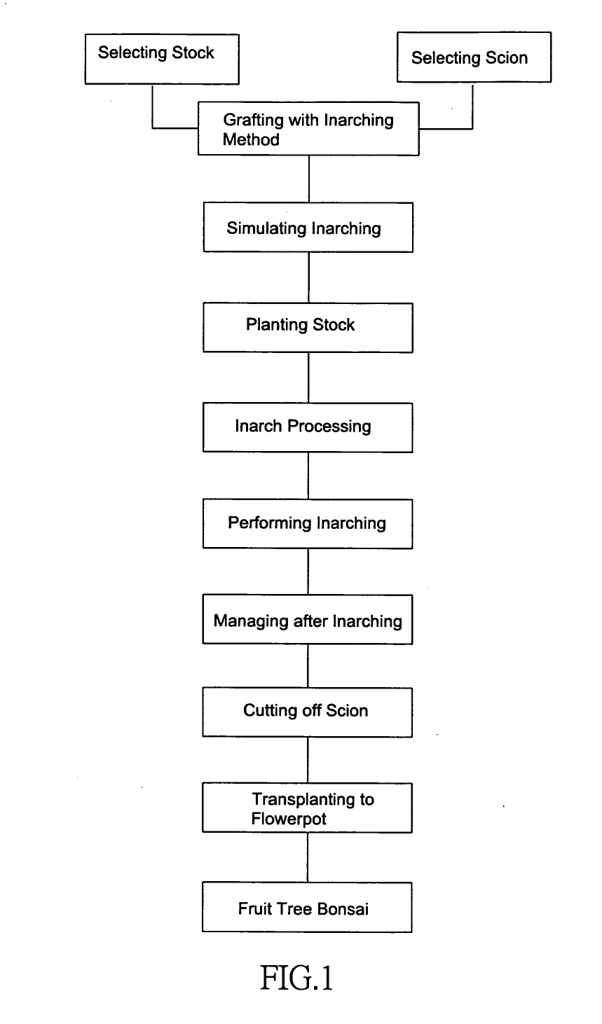

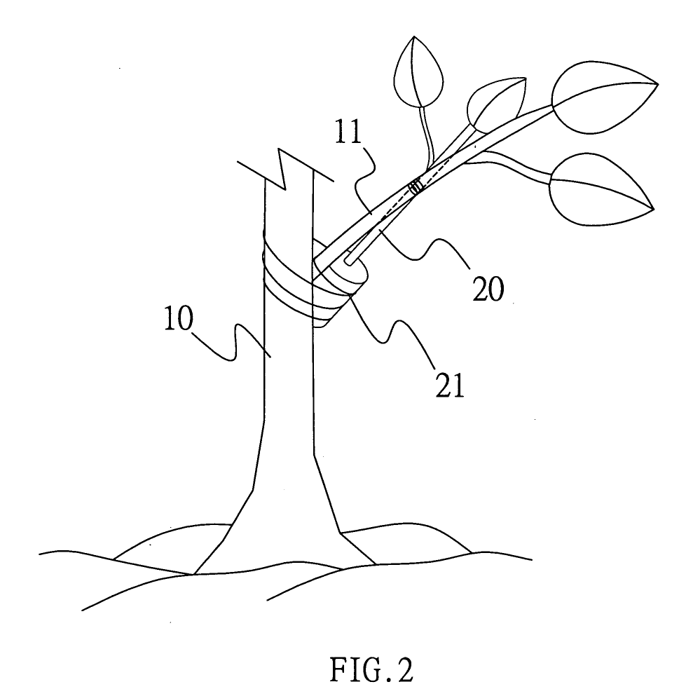

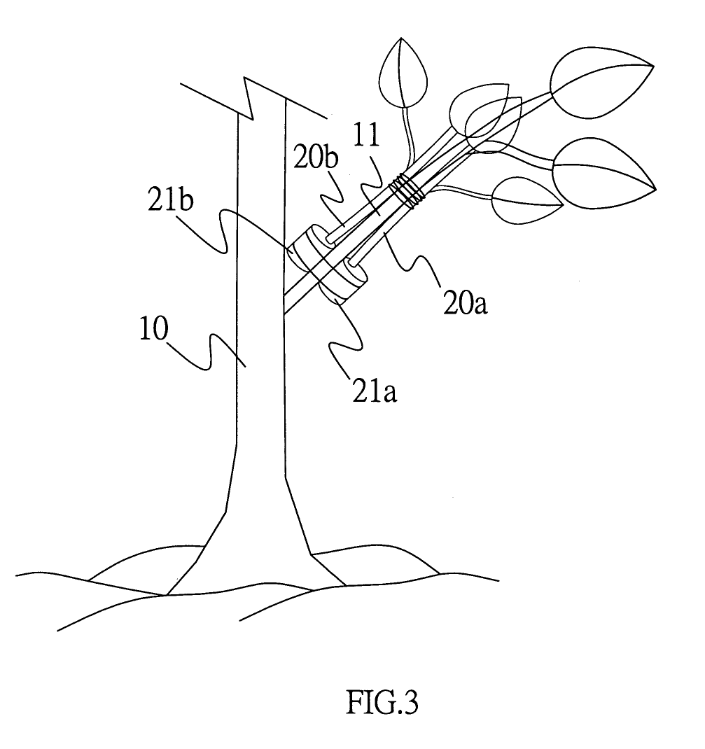

Referring to FIG. 1, it shows a flow diagram of a preferred embodiment of the present invention. As shown in the drawing, the said fruit tree bonsai planting method includes following steps:
1. selecting a scion: selecting as the scion on a stock plant a stub of fruit tree which grows well for more than one year, has a good shape and is able to be ripened and then trimming branches and leaves of the scion to reduce loss of nutrients, allowing the scion to receive the sufficient nutrients to grow and to be ripened;
2. selecting a stock: selecting as the stock a seedling plant which grows more than one year and is same as or similar to the scion in family, genus or species, with a diameter ⅔″ 1 time of the scion, preferably the same; keeping ¼″ ⅓ of branches and leaves after trimming the stock to reduce loss of nutrients, thereby facilitating delivering the nutrients to the scion;
3. performing grafting: using an inarching method to graft the scion with the stock;
4. simulating the inarching: moving close the scion and the stock to pre-simulate inarching the stubs;
5. planting the stock: the method of planting the stock depending upon a height of the scion, including (a) planting the stock in a plastic pot which is then fastened on a stock plant of the scion with a rope or is supported and fixed by a pore; (b) planting the stock in a flowerpot, a bottom of which is provided with plural holes, allowing a root of the stock to extend into soil; (c) plating the stock directly in the soil;
6. inarch processing: cutting off opposite parts of the scion and the stock, deep under xylem to expose cambium;
7. performing inarching: placing in alignment the cambium of the scion with that of the stock and fully sealing them, followed by tightly fastening with a plastic tape or a plastic cloth;
8. managing after inarching: preventing the scion from being ruptured due to weight, a pore or a rope being used to support and fix the stub of the scion; if the stock being suspended in air, then water and the nutrients supply being taken care of as in FIG. 2 and FIG. 3, using a dropping tube or an automatic water collector to supply the nutrients and the water; proper fruit thinning, tree shape trimming and investigation being taken to the scion and new sprouts grown by the stock being able to be cut off or reserved depending upon an amount of the leaves of the scion; usually about ⅓ of the original leaves being kept for the stock to facilitate supplying the nutrients to the scion and according to experiences, a height of the bonsai for various fruit trees at 40″ 120 cm being most appropriate to act as the fruit tree bonsai;
9. cutting off the scion: usually the scion being cut off when (a) the fruits of the scion reaching the condition of acting as the bonsai or the fruits growing to be almost ripened (1″ 2 months prior to be ripened); (b) the inarched location of the scion with the stock being assembled successfully; according to experiences, assembling time varying with the fruit tree and usually the wound being healed within 3″ 4 months and the fruits of the scion growing to be nearly ripened after another 2″ 3 months that a lower part of the scion can be cut off; to increase speed of healing, a wound healing agent being able to be pasted on the inarched location, such that during the healing of the cambiums of the scion and the stock, vascular tissues which go through the both growing rapidly and the wound being prevented from being infected by germs to promote healing and growing and to supply the nutrients to the scion;
10. transplanting to a flowerpot: transplanting the stock to a flowerpot which is provided with good air permeable and fertile soil, the soil being one of or a combination of more than one of garden soil, leaf mould and fine sandy soil, which can continue supplying nutrients to the fruit tree, allowing the fruits of the fruit tree bonsai to be ripened, thereby forming the fruit tree bonsai.

Referring to FIG. 2, it shows a schematic view of a first embodiment of the present invention, disclosing a first kind of stock planting method. In implementing, depending upon a height of the scion, a stock 20 is first planted in a plastic pot 21, and then a stock plant 10 of the scion 11 is wrapped by a rope, followed by inarching the stock 20 and the scion 11.

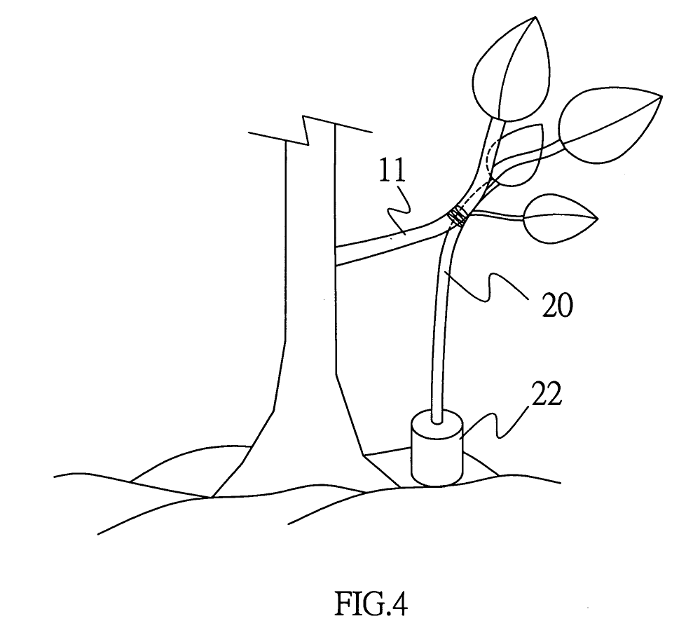

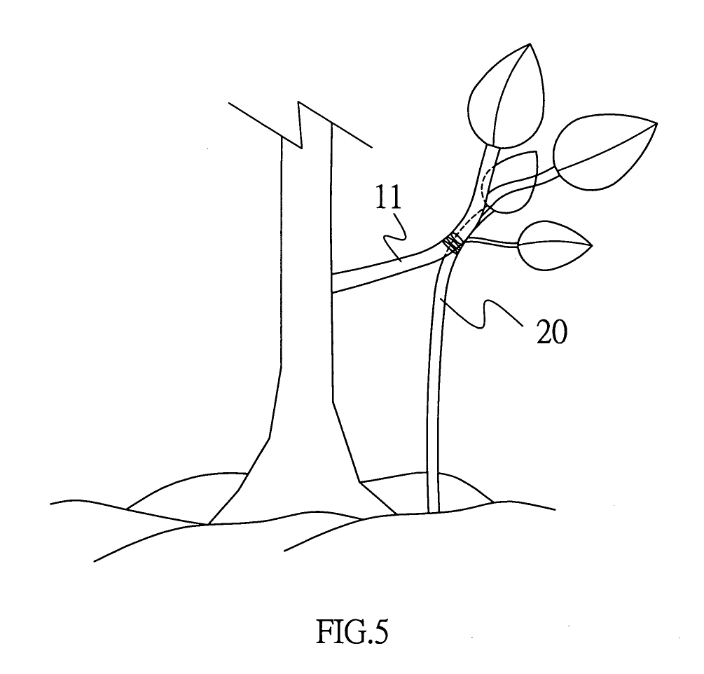

Referring to FIG. 3, it discloses a schematic view of a second embodiment of the present invention, showing a second kind of stock planting method. If two stocks 20a, 20b are used in grafting, then the two stocks 20a, 20b are first planted in plastic pots 21a, 21b which are then wrapped on the scion 11 of the stock plant 10 with ropes, next the two stocks 20a, 20b are inarched with the scion 11 to increase support to the scion 11. Furthermore, as shown in FIG. 4, it discloses a schematic view of a third embodiment of the present invention, showing a third kind of stock planting method. The stock 20 is planted in a flowerpot 22 put on ground and a bottom of the flowerpot 22 is provided with plural holes, allowing a root of the stock 20 to extend into soil, followed by inarching the stock 20 with the scion 11. Whereas, referring to FIG. 5, it shows a schematic view of a fourth embodiment of the present invention, disclosing a fourth kind of stock planting method. In implementing, the stock 20 is directly planted in the soil and then the stock 20 is inarched with the scion 11.

The present invention provides a fruit tree bonsai planting method which uses primarily a feature of plant inarching to supply nutrients by a stock plant of a scion, allowing fruits which are prepared as the bonsai to grow simultaneously with fruits in a garden, wherein a root of the stock is used to supply nutrients to the scion after being cut off from the stock plant, which is provided with following features including that the fruits grow rapidly, with the fruits being ripened in about 6 months to 1 year; the bonsai fruits can be produced in a large quantity, allowing the bonsai fruits to be popularized, inexpensive, more decorative, green making, edible, educational, able to clean air, improve an economical value of the fruits, increase an income of peasants and promote development of agriculture.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A fruit tree bonsai planting method, comprising steps of (a) a scion and a stock are grafted by an inarching method, (b) an inarched location is fastened tightly with a tape, a lower part of the scion is cut off after the inarched location is healed (c) the stock is transplanted to a pot with fertile soil for fixing, thereby forming the fruit tree bonsai.

2. The fruit tree bonsai planting method according to claim 1, wherein more than one stub of the stock is selected to inarch with the scion, so as to increase support to the scion.

3. The fruit tree bonsai planting method according to claim 1, wherein the stock is planted by any one of following steps: (a) planting the stock in a plastic pot which is then fastened with a rope on a stock plant of the scion or is supported and fixed with a pore; (b) planting the stock in a flowerpot, a bottom of which is provided with plural holes, allowing a root of the stock to extend into soil; (c) planting the stock directly in the soil.

4. The fruit tree bonsai planting method according to claim 1, wherein the inarched location is pasted with a wound healing agent.

5. The fruit tree bonsai planting method according to claim 1, wherein the fertile soil is one of or a combination of more than one of garden soil, leaf mould and fine sandy soil.
